(19) United States
(12) Patent Application Publication
(10) Pub. No.: US 2014/0116554 A1
(43) Pub. Date: May 1, 2014

(54) OFF-SITE FECES DISCHARGING SYSTEM

(71) Applicant: Changsha Dongbang Automated Toiler Co., Ltd., Changsha (CN)

(72) Inventor: Delin ZENG, Changsha (CN)

(73) Assignee: Changsha Dongbang Automated Toilet Co., Ltd., Changsha (CN)

(21) Appl. No.: 14/064,231

(22) Filed: Oct. 28, 2013

Related U.S. Application Data
(63) Continuation-in-part of application No. PCT/CN2012/074728, filed on Apr. 26, 2012.

(30) Foreign Application Priority Data
Apr. 26, 2011 (CN) 201110116239.1

(51) Int. Cl. F17D 3/00

(52) U.S. Cl. CPC F17D 3/00
USPC 137/861; 137/624.27

(57) ABSTRACT

A system for draining fecal matter off-site, including: a sealed fecal matter disposal device, an off-site fecal matter outlet, an off-site air charging inlet, a control valve, a fecal matter transporting pipe, and an air transporting pipe. A fecal matter extraction interface is disposed on the off-site fecal matter outlet. An air charging interface is disposed on the off-site air charging inlet. The off-site fecal matter outlet is connected to a straight fecal matter outlet arranged on the sealed fecal matter disposal device via the fecal matter transporting pipe. The off-site air charging inlet is connected to an air inlet arranged on the sealed fecal matter disposal device via the air transporting pipe. The control valve is disposed on the air transporting pipe for controlling the connection or disconnection of the air transporting pipe, thereby realizing permission or refusal of off-site fecal matter extraction.

### CROSS-REFERENCE TO RELATED APPLICATIONS

This application is a continuation-in-part of International Patent Application No. PCT/CN2012/074728 with an international filing date of Apr. 26, 2012, designating the United States, now pending, and further claims priority benefits to Chinese Patent Application No. 201110116239.1 filed Apr. 26, 2011. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to the field of fecal matter disposal, and more particularly to a system for draining fecal matter off-site.

2. Description of the Related Art

A typical method for extracting fecal sludge from a sealed fecal matter disposal device and corresponding fecal matter extracting and carrying facilities all adopt positive pressure to reach clean fecal matter extraction, and harmless and safe disposal.

However, this method does not consider the physical positioning of the fecal matter disposal device, for example, it is inconvenient to extract and transfer the fecal sludge and a normal operation of the toilets cannot be ensured when the fecal matter disposal device is arranged in area that is conveniently accessible for vehicles carrying fecal matter extraction devices, and the sealed fecal matter disposal device is arranged in scenic spots where the road is difficult for passage or in urban lanes where the vehicles carrying the fecal matter extraction devices are unable to access.

### SUMMARY OF THE INVENTION

In view of the above-described problems, it is one objective of the invention to provide a system for draining fecal matter off-site.

To achieve the above objective, in accordance with one embodiment of the invention, there is provided a system for draining fecal matter off-site, comprising: a sealed fecal matter disposal device, the sealed fecal matter disposal device comprising an air inlet and a straight fecal matter outlet; an off-site fecal matter outlet, the off-site fecal matter outlet comprising a fecal matter extraction interface; an off-site air charging inlet, the off-site air charging inlet comprising an air charging interface; a control valve; a fecal matter transporting pipe; and an air transporting pipe. The fecal matter extraction interface is disposed on the off-site fecal matter outlet. The air charging interface is disposed on the off-site air charging inlet. The off-site fecal matter outlet is connected to the straight fecal matter outlet arranged on the sealed fecal matter disposal device via the fecal matter transporting pipe. The off-site air charging inlet is connected to the air inlet arranged on the sealed fecal matter disposal device via the air transporting pipe. The control valve is disposed on the air transporting pipe for controlling a connection or disconnection of the air transporting pipe, thereby realizing permission or refusal of off-site fecal matter extraction.

In a class of this embodiment, a fecal matter control valve is in series connection with the fecal matter transporting pipe close to the off-site fecal matter outlet. An air control valve is in series connection with the air transporting pipe close to the off-site air charging inlet. A connecting branch is disposed between the fecal matter transporting pipe for connecting the fecal matter control valve and the off-site fecal matter outlet and the air transporting pipe for connecting the air control valve and the off-site air charging inlet. A branch valve is in series connection with the connecting branch to form a structure for clearing fecal residue.

In a class of this embodiment, the pressure generating device is arranged close to the off-site air charging inlet or the off-site fecal matter outlet. The off-site air charging inlet is directly connected to the pressure generating device.

In a class of this embodiment, the pressure generating device is arranged close to the off-site air charging inlet or the off-site fecal matter outlet. The off-site air charging inlet is directly connected to the pressure generating device.

In accordance with one embodiment of the invention, there is provided a system for draining fecal matter off-site, comprising: a sealed fecal matter disposal device; an off-site fecal matter discharging branch, the off-site fecal matter transporting branch comprising a fecal matter transporting pipe comprising an off-site fecal matter outlet; and an air inlet branch, the air vent branch comprising an air transporting pipe comprising an off-site air charging inlet. The off-site fecal matter discharging branch and the air inlet branch are in parallel connection. Both the fecal matter transporting pipe and the air transporting pipe communicate with the sealed fecal matter disposal device. A control valve is disposed on the air transporting pipe close to the sealed fecal matter disposal device. Both the off-site fecal matter outlet and the off-site air charging inlet are separated from the sealed fecal matter disposal device.

In a class of this embodiment, the fecal matter transporting pipe comprises a straight fecal matter outlet. The fecal matter transporting pipe is connected to the sealed fecal matter disposal device via the straight fecal matter outlet. The air transporting pipe comprises an air outlet. The air transporting pipe is connected to the sealed fecal matter disposal device via the air outlet.

In a class of this embodiment, a fecal matter control valve is in series connected with the fecal matter transporting pipe.

In a class of this embodiment, two ends of a connecting branch are connected to a first position between the off-site fecal matter outlet and the fecal matter control valve and a second position between the off-site air charging inlet and the control valve, respectively. A branch valve is disposed on the connecting branch.

In a class of this embodiment, an air control valve is disposed on the air transporting pipe between the off-site air charging inlet and the control valve close to the off-site air charging inlet.

In a class of this embodiment, an air inlet of the air transporting pipe is connected to a pressure generating device.

In a class of this embodiment, the pressure generating device is arranged close to the sealed fecal matter disposal device.

In a class of this embodiment, the control valve is a check valve.

Advantages of the invention are summarized as follows: The system for draining fecal matter off-site of the invention enables the sealed fecal matter disposal device to discharge fecal matter in off-site or remote regions. The system of the invention also enables the fecal matter transporting pipe to off-site clean the fecal residue. The system of the invention is suitable to the sealed fecal matter disposal method, the fecal matter extraction method by positive pressure, and the fecal matter extraction method by positive and negative pressure, thereby facilitating the applications of such fecal matter extraction methods.

### BRIEF DESCRIPTION OF THE DRAWINGS

FIG. 1 is a structure diagram of a system for draining fecal matter off-site in accordance with Example 1;

FIG. 2 is a structure diagram of a system for draining fecal matter off-site in accordance with Example 2;

FIG. 3 is a structure diagram of a system for draining fecal matter off-site in accordance with Example 3; and

FIG. 4 is a structure diagram of a system for draining fecal matter off-site in accordance with Example 4.

### DETAILED DESCRIPTION OF THE EMBODIMENTS

For further illustrating the invention, experiments detailing a system for draining fecal matter off-site are described below. It should be noted that the following examples are intended to describe and not to limit the invention.

### Example 1

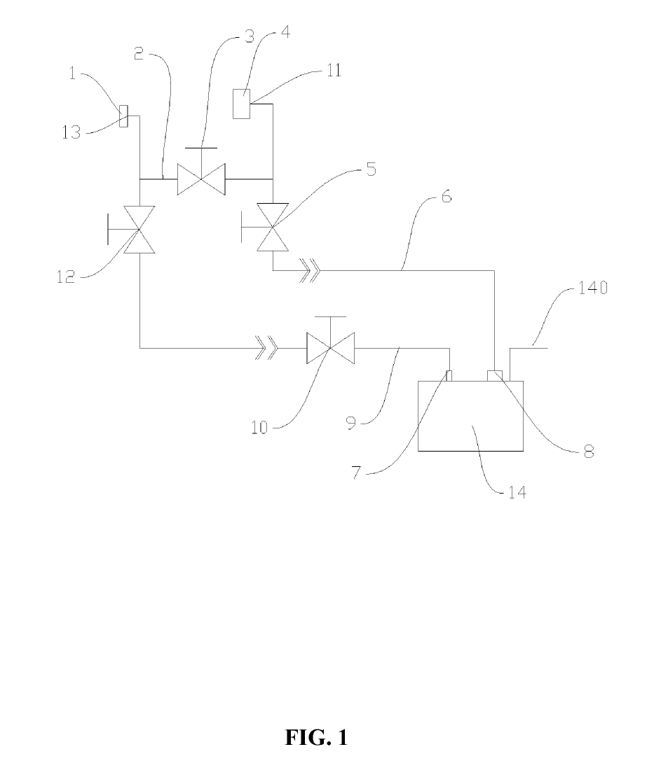

As shown in FIG. 1, a system for draining fecal matter off-site comprises a first pipeline branch and a second pipeline branch. The first and the second pipeline branches are in parallel connection and both communicate with a sealed fecal matter disposal device 14. The first pipeline is a branch for off-site fecal matter discharge and comprises a fecal matter transporting pipe 6, a straight fecal matter outlet 8, and an off-site fecal matter outlet 11. The length of the fecal matter transporting pipe 6 is adjustable according to practical requirement. The straight fecal matter outlet 8 and the off-site fecal matter outlet 11 are disposed at two ends of the fecal matter transporting pipe 6. The fecal matter transporting pipe 6 communicates with the sealed fecal matter disposal device 14 via the straight fecal matter outlet 8. The off-site fecal matter outlet 11 is separated from the sealed fecal matter disposal device 14. For example, the off-site fecal matter outlet 11 is arranged in an area that is conveniently accessible for vehicles carrying fecal matter extraction devices, and the sealed fecal matter disposal device 14 is arranged in scenic spots where the road is difficult for passage or in urban lanes where the vehicles carrying the fecal matter extraction devices is unable to access. For another example, the sealed fecal matter disposal device 14 is disposed in a condensed residential area, and the off-site fecal matter outlet 11 is disposed in crop area or in mountains that necessitate irrigation. To realize a proper or urgent disconnection of fecal matter extraction during the off-site fecal matter extraction, preferably, a fecal matter control valve 5 is disposed on the fecal matter transporting pipe 6 close to the off-site fecal matter outlet 11 for controlling the connection and disconnection of the fecal matter transporting branch. In order to connect the off-site fecal matter outlet 11 and a fecal matter extraction device, preferably, the off-site fecal matter outlet 11 is provided with a fecal matter extraction interface 4 for connecting a dynamic fecal matter extraction device.

The second pipeline branch is an air inlet branch comprising an air transporting pipe 9, an off-site air charging inlet 13, and an air outlet 7. The length of the air transporting pipe 9 is adjustable according to practical requirement, and the off-site air charging inlet 13 and the air outlet 7 are disposed on two ends of the air transporting pipe 9. The off-site air charging inlet 13 and the sealed fecal matter disposal device 14 are arranged in two separated areas. For example, the off-site fecal matter outlet 11 is separated from the sealed fecal matter disposal device 14. For example, the off-site fecal matter outlet 11 is arranged in an area that is conveniently accessible for vehicles carrying fecal matter extraction devices, and the sealed fecal matter disposal device 14 is arranged in scenic spots where the road is difficult for passage or in urban lanes where the vehicles carrying the fecal matter extraction devices is unable to access. For another example, the sealed fecal matter disposal device 14 is disposed in a condensed residential area, and the off-site fecal matter outlet 11 is disposed in crop area or in mountains that necessitate irrigation. The air transporting pipe 9 is connected to the sealed fecal matter disposal device 14 via the air outlet 7. A control valve 10 is disposed between the air transporting pipe 9 and the sealed fecal matter disposal device 14 for controlling the connection and disconnection of the air inlet branch. Meanwhile, the control valve 10 is arranged close to the sealed fecal matter disposal device 14. The holder or the manager of the sealed fecal matter disposal device 14 is capable of controlling the permission or refusal of the fecal matter extraction from the sealed fecal matter disposal device 14, thereby preventing the fecal matter from being stolen without permission. In order to conveniently connect the off-site air charging inlet 13 to the fecal matter extraction device by air pressure, preferably, the off-site air charging inlet 13 is provided with an air charging interface 1, and the air charging interface 1 is generally connected to a pressure generating device arranged on the dynamic fecal matter extraction device.

It is known from the above that distances from the sealed fecal matter disposal device 14 to the off-site fecal matter outlet 11 and to the off-site air charging inlet 13 are determined by lengths of the fecal matter transporting pipe 6 and the air transporting pipe 9. The longer the fecal matter transporting pipe 6 and the air transporting pipe 9 are, the longer distance for controlling off-site fecal matter discharge is realized by the system for draining fecal matter off-site of the invention.

Preferably, the system of the invention further comprises a structure for clearing fecal residue in order to separate the fecal matter extraction device from the fecal matter extraction interface or from the off-site fecal matter outlet 11 after the off-site fecal matter extraction process and to prevent the fecal residue from dropping out of the fecal matter extraction pipe thereby resulting in environmental pollution. The structure for clearing fecal residue comprises a connecting branch 2 and a branch valve 3 disposed on the connecting branch 2. A first position of the connecting branch 2 is disposed on the fecal matter transporting pipe 6 between the off-site fecal matter outlet 11 and the fecal matter control valve 5, and a second position of the connecting branch 2 is disposed on the air transporting pipe 9 between the off-site air charging inlet 13 and the control valve 10.

The first pipeline branch and the second pipeline branch are buried in the earth or arranged on the land to ensure a safe use of the pipelines. That is, the fecal matter transporting pipeline 6 and the air transporting pipeline 9 are exposed on the land surface or buried in the earth, and meanwhile, the fecal matter transporting pipeline 6 and the air transporting pipeline 9 are pipelines made of common materials, devices, or temperature-insulated pipelines.

When using the system for draining fecal matter off-site, the control valve 10 and the fecal matter control valve 5 are started and the branch valve 3 is closed. The air passes through the off-site air charging inlet 13 and the air transporting pipe 9 to the sealed fecal matter disposal device 14, and the air pressure increases inside the sealed fecal matter disposal device 14, so that the fecal sludge therein is introduced though the fecal matter transporting pipe 6 and the off-site fecal matter outlet 11 to enter a fecal sludge carrying device arranged on the fecal matter extraction device. Such processes are repeated until the fecal sludge is extracted out of the sealed fecal matter disposal device 14. After the off-site fecal matter extraction is completed, the operation for cleaning the fecal residue is conducted. The air control valve 12 and the fecal matter control valve 5 are shut off, and the branch valve 3 is open. The air is introduced from the off-site air charging inlet 13, passes through the connecting branch 2, and enters the fecal matter transporting pipe 6 to press fecal residues in the section between the first position of the connecting branch 2 and the fecal matter extraction interface 4 and in the fecal matter extraction pipe of the fecal matter extraction device to the carrying tank of the fecal matter extraction device, thereby cleaning the fecal matter extraction pipe. Preferably, to conveniently conduct the operation for off-site fecal matter cleaning, the air control valve 12 is disposed on the air transporting pipe 9 between the off-site air charging inlet 13 and the control valve 10 close to the off-site air charging inlet 13 for further controlling the connection and disconnection of the air inlet branch. The control valve 10 is in a connected or disconnected state. Such a structure enables the process of cleaning the fecal residue to be finished close to the fecal matter extraction device, rather than off-site calling another to control the disconnection of the control valve 10.

As shown in FIG. 1, the system further comprises a third pipeline branch, that is, a fecal matter accepting pipeline 140 for connecting to the fecal matter acceptors in toilets. The fecal matter accepting pipeline 140 is required to be closed during the process of off-site fecal matter extraction of the system.

### Example 2

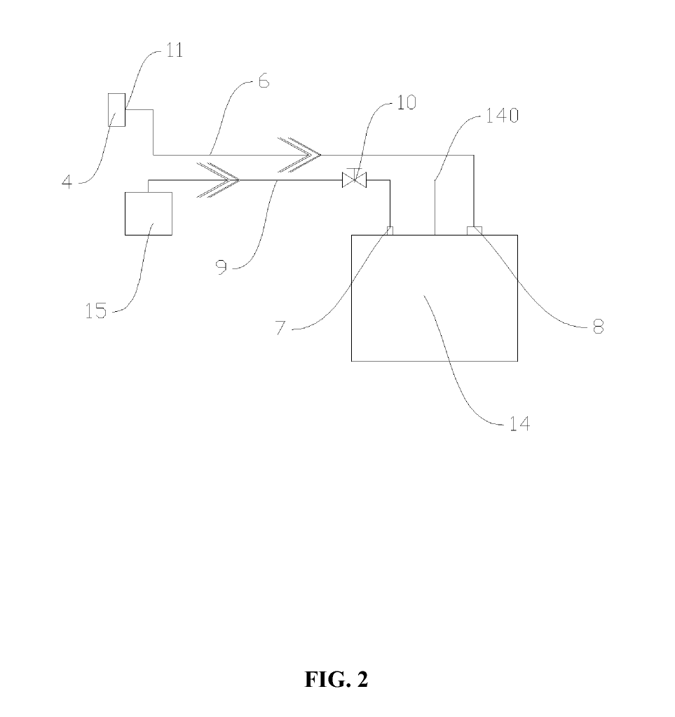

As shown in FIG. 2, the system for draining fecal matter off-site in Example 2 is the same as that in Example 1 except that the system in Example 2 deletes the arrangement of the device for cleaning the fecal residue, that is, the connecting branch 2, the branch valve 3, and the air charging interface 1 are canceled, and the off-site air charging inlet 13 is directly connected to a pressure generating device 15.

Or the fecal matter control valve 5 and the air control valve 12 are canceled, and only the control valve 10 is remained. The control valve 10 is used to realize the permission or refusal of the off-site fecal matter discharge and to prevent the corrosive gas in the sealed fecal matter disposal device 14 from back flowing to the pressure generating device 15, thereby preventing the pressure generating device 15 from corrosion and pollution.

### Example 3

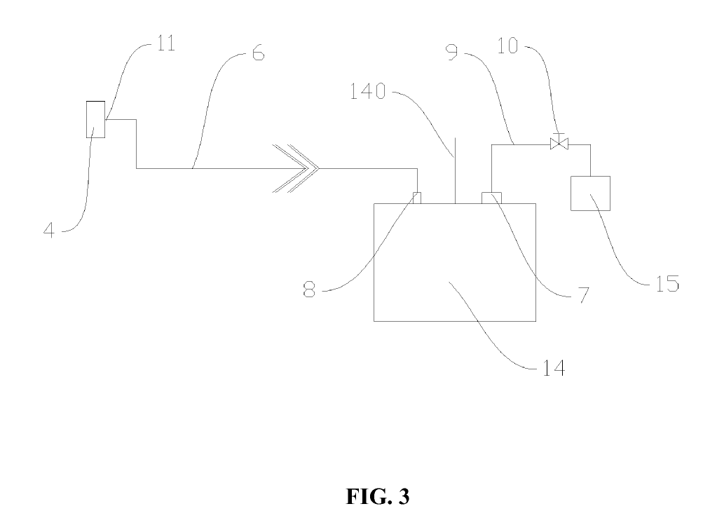

As shown in FIG. 3, the system for draining fecal matter off-site in Example 3 is the same as that in Example 2 except that the pressure generating device 15 of the system of Example 3 is arranged close to the sealed fecal matter disposal device 14 and is far away from the off-site fecal matter outlet 11.

### Example 4

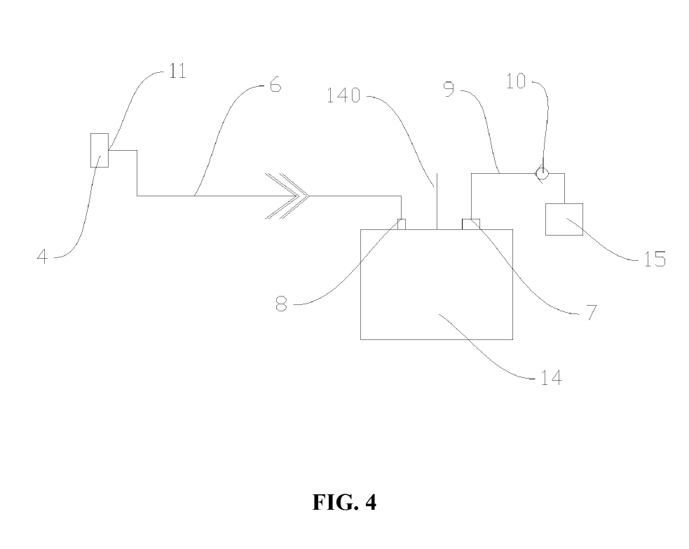

As shown in FIG. 4, a system for draining fecal matter off-site in Example 4 is the same as that in Example 3 in that the control valve 10 of the off-site fecal matter discharge system of Example 4 is a check valve. The check valve has the following advantages: on one hand, the air inlet branch is opened without manually rotating the control valve; and on the other hand, corrosive gases including methane in the sealed fecal matter disposal device 14 is prevented from back flowing to the pressure generating device 15, thereby preventing the pressure generating device 15 from corrosion and pollution.

The system for draining fecal matter off-site of the invention enables the sealed fecal matter disposal device 14 to discharge fecal matter in off-site or remote regions. The system of the invention also enables the fecal matter transporting pipe to off-site clean the fecal residue. The system of the invention is suitable to the sealed fecal matter disposal method, the fecal matter extraction method by positive pressure, and the fecal matter extraction method by positive and negative pressure, thereby facilitating the applications of such fecal matter extraction methods.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A system for draining fecal matter off-site, comprising:
a) a sealed fecal matter disposal device, the sealed fecal matter disposal device comprising an air inlet (7) and a straight fecal matter outlet (8);
b) an off-site fecal matter outlet (11), the off-site fecal matter outlet (11) comprising a fecal matter extraction interface (4);
c) an off-site air charging inlet (13), the off-site air charging inlet (13) comprising an air charging interface (1);
d) a control valve (10);
e) a fecal matter transporting pipe (6); and
f) an air transporting pipe (9);
wherein
the fecal matter extraction interface (4) is disposed on the off-site fecal matter outlet (11);
the air charging interface (1) is disposed on the off-site air charging inlet (13);
the off-site fecal matter outlet (11) is connected to the straight fecal matter outlet (8) arranged on the sealed fecal matter disposal device via the fecal matter transporting pipe (6);
the off-site air charging inlet (13) is connected to the air inlet (7) arranged on the sealed fecal matter disposal device via the air transporting pipe (9); and
the control valve (10) is disposed on the air transporting pipe (9) for controlling a connection or disconnection of the air transporting pipe (9), thereby realizing permission or refusal of off-site fecal matter extraction.

2. The system of claim 1, wherein
A fecal matter control valve (5) is in series connection with the fecal matter transporting pipe (6) close to the off-site fecal matter outlet (11);
An air control valve (12) is in series connection with the air transporting pipe (9) close to the off-site air charging inlet (13);
a connecting branch (2) is disposed between the fecal matter transporting pipe (6) for connecting the fecal matter control valve (5) and the off-site fecal matter outlet (11) and the air transporting pipe (9) for connecting the air control valve (12) and the off-site air charging inlet (13); and
a branch valve (3) is in series connection with the connecting branch (2) to form a structure for clearing fecal residue.

3. The system of claim 1, wherein
a pressure generating device is arranged close to the off-site air charging inlet (13) or the off-site fecal matter outlet (11); and
the off-site air charging inlet (13) is directly connected to the pressure generating device.

4. The system of claim 2, wherein
the pressure generating device is arranged close to the off-site air charging inlet (13) or the off-site fecal matter outlet (11); and
the off-site air charging inlet (13) is directly connected to the pressure generating device.

5. A system for draining fecal matter off-site, comprising:
a) a sealed fecal matter disposal device (14);
b) an off-site fecal matter discharging branch, the off-site fecal matter transporting branch comprising a fecal matter transporting pipe (6) comprising an off-site fecal matter outlet (11); and
c) an air inlet branch, the air vent branch comprising an air transporting pipe (9) comprising an off-site air charging inlet (13);
wherein
the off-site fecal matter discharging branch and the air inlet branch are in parallel connection;
both the fecal matter transporting pipe (6) and the air transporting pipe (9) communicate with the sealed fecal matter disposal device (14);
a control valve (10) is disposed on the air transporting pipe (9) close to the sealed fecal matter disposal device (14); and
both the off-site fecal matter outlet (11) and the off-site air charging inlet (13) are separated from the sealed fecal matter disposal device (14).

6. The system of claim 5, wherein
The fecal matter transporting pipe (6) comprises a straight fecal matter outlet (8);
The fecal matter transporting pipe (6) is connected to the sealed fecal matter disposal device (14) via the straight fecal matter outlet (8);
The air transporting pipe (9) comprises an air outlet (7); and
the air transporting pipe (9) is connected to the sealed fecal matter disposal device (14) via the air outlet (7).

7. The system of claim 5, wherein a fecal matter control valve (5) is in series connected with the fecal matter transporting pipe (6).

8. The system of claim 7, wherein
two ends of a connecting branch (2) are connected to a first position between the off-site fecal matter outlet (11) and the fecal matter control valve (5) and a second position between the off-site air charging inlet (13) and the control valve (10), respectively; and
a branch valve is disposed on the connecting branch (2).

9. The system of claim 8, wherein an air control valve (12) is disposed on the air transporting pipe (9) between the off-site air charging inlet (13) and the control valve (10) close to the off-site air charging inlet (13).

10. The system of claim 5, wherein an air inlet of the air transporting pipe (9) is connected to a pressure generating device.

11. The system of claim 10, wherein the pressure generating device (15) is arranged close to the sealed fecal matter disposal device (14).

12. The system of claim 10, wherein the control valve (10) is a check valve.
